(19) United States
(12) Patent Application Publication
(10) Pub. No.: US 2003/0055887 A1
(43) Pub. Date: Mar. 20, 2003

(54) Method for extending a data network connection

(76) Inventors: Ulrich Mitreuter, Koenigsdorf (DE); Renate Zygan-Maus, Muenchen (DE)

Correspondence Address: Morrison & Foerster LLP, Suite 300, 1650 Tysons Boulevard, McLean, VA, 22102, US

(21) Appl. No.: 10/214,440

(22) Filed: Aug. 8, 2002

(30) Foreign Application Priority Data
Aug. 10, 2001 (EP) 01119363.8

(51) Int. Cl. G06F 15/16; H04L 12/16; H04Q 11/00

(52) U.S. Cl. 709/203; 709/205; 370/260

(57) ABSTRACT

A help session for Internet offers is provided using the “click-to-dial” service. The invention involves extending this service such that, by way of example, an employee at a call center (CC) can provide a user with an efficient, interactive help session.

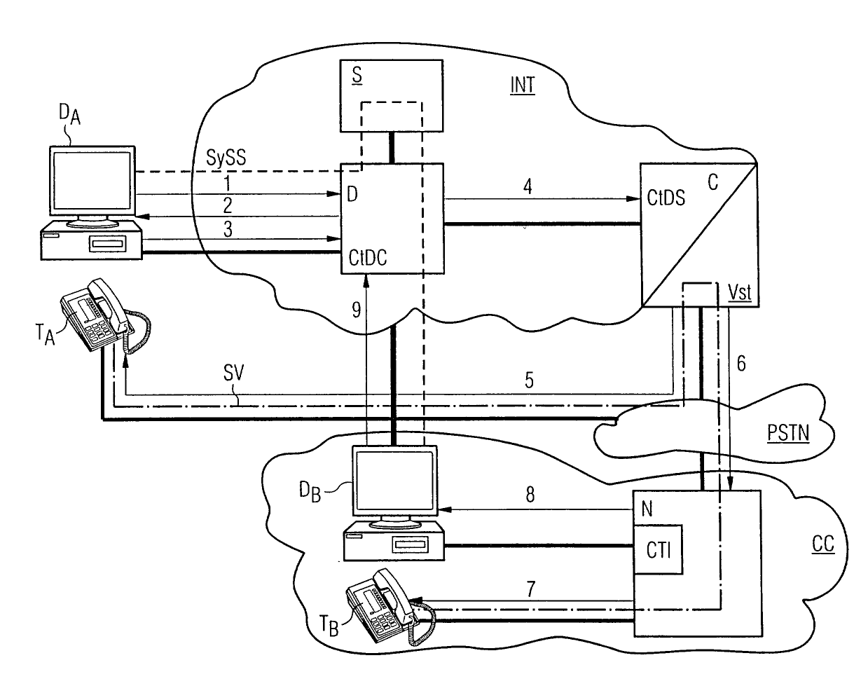

A large number of Internet providers present extensive and complex offers on the Internet, e.g. services in the field of banking and finance, such as Internet securities information services, which, particularly for inexperienced users, can normally be used only to a limited extent without any assistance. Using an interactive form of help session which is simple for the user to use, for example by virtue of an employee at a call center, the Internet provider can increase the usefulness and hence the acceptance of his offer in this context.

A help session for Internet offers is provided using the “click-to-dial” service. The click-to-dial service sets up a telephone connection between the user's telephone device and, by way of example, the telephone device of an employee at the call center upon request, for example as a result of the user activating a button, provided for this purpose, on an Internet page displayed to the user from the provider, when prompted by an existing Internet connection from the user. This provides the user with a simple way of setting up a telephone connection to the provider's competent call center without knowledge of the call number for the call center and without manual selection of the provider's call center competent to deal with the enquiry—e.g. different call centers are provided for questions regarding content and technical matters.

However, the click-to-dial service does not provide the user with adequate help, since the user needs to enter the Internet pages quoted by the employee at the call center manually into his Internet browser using the addresses of these pages, in which case, in the case of dynamically generated Internet contents, there is no certainty that the same Internet contents will be displayed to the call center employee and to the user at the same address. In addition, when looking at the Internet pages together during the help session, the employee at the call center and the user need to make constant exchanges regarding their respective steps, for example the buttons pressed or links used, so that the same Internet contents are displayed to the employee at the call center and to the user.

The present invention is based on the object of improving the click-to-dial service.

This object is achieved, on the basis of a method for extending an existing data network connection in accordance with the features of the precharacterizing clause of patent claim 1, by the characterizing features of said patent claim.

A fundamental advantage of the inventive method is that it is possible to provide an extended service in which the user of a data network offer is afforded, by means of a simple action, e.g. clicking on a button (provided for this purpose by the provider of the data network offer) on a data network page displayed to the user on his screen, a way of automatically extending the existing data network connection to produce a data network conference with an employee at a call center associated with the provider and of setting up a voice link in parallel, for example in order to obtain help regarding a particular data network page within the provider's data

network offer. Likewise automatically, the first data network page displayed both to the employee at the call center and to the user in this case is the data network page which forms the starting point for the user's enquiry.

This data network conference can be controlled either just by the user or just by the employee at the call center or by both—claim 2. It is thus possible to stipulate, for example, that only the employee at the call center can control the data network conference and can prescribe new data network pages.

Advantageously, the synchronized surfing service is used for the data network conference—claim 3. The synchronized surfing Internet service—synchronized display of network contents—permits two or more Internet users to look at Internet contents together on their respective screens, i.e. whenever one of the Internet users clicks on a link, this automatically results in the Internet page selected by this link being simultaneously displayed to all the participants in the synchronized surfing session. The synchronized surfing session is identified by a unique identifier—session ID. If an Internet user is authorized to participate in a synchronized surfing session, he sets up an HTTP connection—Hyper Text Transfer Protocol—between a personal computer and the service server managing the synchronized surfing session on the Internet and transfers the session ID of the synchronized surfing session as a parameter.

In accordance with one advantageous refinement of the inventive method, the data required for initiating and coordinating the voice link and the synchronized surfing session are transferred using signaling messages in the telephone network—claims 4 and 5. In this case, it is advantageous that known and standardized signaling messages are used which merely require alignment with the private branch exchange at the provider's call center, but do not require any changes to the switching centers in the telephone network.

If the user has only an analog telephone line without separate access to the data network, the telephone line is used for dialing up the data network or Internet—claims 8 and 9. The voice link is then advantageously provided over the data network connection, e.g. using the Voice over IP mechanism.

Further advantageous refinements of the invention can be found in the subclaims.

The inventive method is explained in more detail below with reference to a drawing.

The figure shows a telephone T_{A} and a personal computer D_{A} associated with a user. The personal computer D_{A} is connected to the Internet INT. This personal computer D_{A} retrieves contents, provided for retrieval, from a provider's service server D on the Internet INT and displays them on a screen associated with the user. Some or all of the Internet pages in this Internet offer contain special help buttons which, when activated by the user, start an inventive interactive help session.

Furthermore, the service server D achieves the object of a click-to-dial user CtDC—click-to-dial client—and is connected to a synchronized surfing server S by means of Internet protocol and to a call server C by means of the protocols SIP/PINT—Session Initiation Protocol/Public Switched Telephone Network and Internet Internetworking. In one refinement, the functions of the service server D and the functions of the synchronized surfing server S are combined in a single server (not shown).

The synchronized surfing server S is a server for the Internet INT which contains all the means required for setting up and managing a synchronized surfing session SySS.

The call server C is both part of the Internet INT and a switching center Vst in the public telephone network PSTN—Public Switched Telephone Network. In one possible refinement, it is a switching center Vst with a connected Internet Server (not shown). This connected Internet server contains the click-to-dial server CtDS function and, in a further refinement, also the Voice over IP gateway function (not shown).

The public telephone network PSTN likewise has the private branch exchange N in the provider's call center CC connected to it. This private branch exchange N contains a CTI server CTI—Computer Telephony Interface Server, which has means for determining a server ID for the synchronized surfing server S and a session ID for the synchronized surfing session SySS from a suffix call number for incoming calls.

The workstation of an employee at the call center CC, comprising a further telephone T_{B} and a further personal computer D_{B}, is connected to the private branch exchange N. In this case, the connection between the further personal computer D_{B} and the private branch exchange N is in a form such that the private branch exchange N can transmit the server ID of the synchronized surfing server S and the session ID of the synchronized surfing session SySS and can send a command for connecting to the synchronized surfing session SySS with this server ID and session ID to the further personal computer D_{B}. In one advantageous refinement, the further telephone T_{B} is integrated as a data network telephone into the further personal computer D_{B} (not shown). The voice information is then transmitted between the employee's workstation and the private branch exchange N using Voice over IP via said connection between the private branch exchange N and the further personal computer D_{B}.

The text below explains the operations denoted by 1..9 which are performed between said devices in order to extend a data network connection to produce a voice link SV and a synchronized surfing session SySS between the user and an employee of the provider. These operations are triggered by the user who needs help regarding a particular Internet page in the provider's Internet offer. The user's activation of a help button provided by the provider triggers the following steps:

1. The user's screen displays a request asking for the call number on which to call back and whether the user wishes to participate in a synchronized surfing session SySS with an employee at the call center CC. In one advantageous refinement, the corresponding details (call number of the user's telephone T_{A}, desire to participate in synchronized surfing sessions SySS which are offered) can be stored on the user's personal computer D_{A}, e.g. as standard values. If the user confirms that he wishes to participate in a synchronized surfing session—this will be assumed below—the service server D, which contains the logic of the click-to-dial service and has a connection to the synchronized surfing server S, prompts starting of a synchronized surfing session SySS. Upon request by the service server D, the synchronized surfing server S produces a synchronized surfing session SySS which is referenced by a unique session ID and the server ID of the synchronized surfing server S.

2. A synchronized surfing applet is loaded into the user's personal computer DA, and the server ID of the synchronized surfing server S on which the synchronized surfing session SySS is running and the session ID of the synchronized surfing session SySS are transferred to this synchronized surfing applet.

3. The synchronized surfing applet uses the session ID of the synchronized surfing session SySS and the server ID of the synchronized surfing server to set up a connection to the synchronized surfing session SySS. The user thus becomes a participant in the synchronized surfing session SySS.

4. Setup of the voice link SV to the private branch exchange N at the call center CC is then prompted by the service server D. As a call number, the telephone number of the call center CC together with a suffix call number are used and are sent to the call server C. This suffix call number for the call number of the private branch exchange N at the call center CC is composed of the server ID of the synchronized surfing server S and of the session ID of the synchronized surfing session SySS—both IDs are digit strings of fixed length. The service server D likewise prompts setup of the voice link SV to the user's telephone T_{A}. The call number used is the call number indicated by the user, which is sent to the call server C.

5. The voice link SV to the telephone T_{A} is set up by the call server C.

6. The call server C sets up the voice link SV to the private branch exchange N at the call center CC.

7. The CTI server CTI—Computer Telephony Interface server, integrated into the private branch exchange N—at the call center CC removes the suffix call number and forwards the call to the further telephone T_{B} of a free employee at the call center CC.

8. At the same time the server ID of the synchronized surfing server S and the session ID of the synchronized surfing session SySS are ascertained from the suffix call number by the CTI server CTI and are transmitted to the call center software on the further personal computer D_{B} of the employee at the call center CC.

9. On the further personal computer D_{B} of the employee at the call center CC, the call center software automatically starts an HTTP browser, and this is connected to the synchronized surfing session SySS using the session ID of the synchronized surfing session SySS and the server ID of the synchronized surfing server S.

The employee is now able both to answer the user's questions efficiently by telephone immediately and to demonstrate the provider's Internet offer to a user using synchronized surfing.

The invention is not limited to the exemplary embodiment. It is thus possible, by way of example, for the voice terminals (T_{A}, T_{B}) to be connected independently of one another using Voice over IP.

If the user's telephone T_{A} is connected using Voice over IP, the function of the telephone T_{A} is integrated into the user's personal computer D_{A}, for example, and the Voice over IP gateway function of the call server C is used to allow connection to the appliance D_{A}.

The further telephone T_{B} of the employee at the call center CC is connected using Voice over IP by integrating the function of the further telephone T_{B} into the further personal computer D_{B} of the employee at the call center CC, for example, and transferring the voice information via the existing connection between the further personal computer D_{B} and the private branch exchange N, the private branch exchange N serving as a Voice over IP gateway between the local communications network at the provider's call center CC and the public telephone network PSTN.

1. A method for extending a data network connection existing between a data network server (D) and a data network terminal (D_{A}), in which an action on the data network terminal (D_{A}) sets up a voice link (SV) between a voice terminal (T_{A}) associated with the data network terminal (D_{A}) and a further voice terminal (T_{B}), characterized in that the action for setting up the voice link (SV) or a further action on the data network terminal (D_{A}) initiates a data network conference call (SySS) which is controlled by the data network server (D) and is denoted by a conference identifier, with at least the data network terminal (D_{A}) and a further data network terminal (D_{B}) associated with the further voice terminal (T_{B}) automatically being included in the data network conference call (SySS).

2. The method as claimed in claim 1, characterized in that the data network conference call (SySS) is controlled by the data network terminal (D_{A}) or by the further data network terminal (D_{B}) or by both.

3. The method as claimed in claim 1, characterized in that the synchronized surfing session (SySS) is set up using a network element (D, S, C, N) which is simultaneously part of the data network (INT) and of a voice network (PSTN) or using a group (D, S, C, N) of network elements, with at least one network element (D, S, C) being part of the data network (INT) and with at least one network element (C, N) being part of a voice network (PSTN).

4. The method as claimed in claim 1, characterized in that the data network conference call (SySS) is a synchronized surfing session (SySS) with the conference identifiers of server ID for a synchronized surfing server (S) and session ID for the synchronized surfing session (SySS).

5. The method as claimed in claim 1, characterized in that the synchronized surfing session (SySS) and the voice link (SV) are initiated and coordinated by using signaling messages from the telephone network (PSTN).

6. The method as claimed in claim 5, characterized in that a voice link (SV) to a private branch exchange (N) is prompted by the data network server (D) and is set up by a switching center (C) having an integrated data network server, the call number of the private branch exchange (N) being used together with a suffix call number, and the suffix call number being compiled from the server ID of the synchronized surfing server (S) and from the session ID of the synchronized surfing session (SySS).

7. The method as claimed in claim 1, characterized
in that the voice terminals (T_{A}, T_{B}) are analog or digital telephones,
in that the connection between the voice terminals (T_{A}, T_{B}) is a connection in the circuit-switched telephone network (PSTN).

8. The method as claimed in claims 1, characterized
in that a voice terminal (T_{A}, T_{B}) is an analog or digital telephone,
in that a further voice terminal (T_{A}, T_{B}) is a data network terminal with a telephony function,
in that the connection between the voice terminals (T_{A}, T_{B}) is firstly a connection in the circuit-switched telephone network (PSTN) and secondly a data network connection, the data network (INT) and the telephone network (PSTN) being connected via a gateway device (C, N).

9. The method as claimed in claim 1, characterized
in that the voice terminals (T_{A}, T_{B}) are data network terminals with a telephony function,
in that the connection between the voice terminals (T_{A}, T_{B}) is a data network connection.

10. The method as claimed in claim 1, characterized in that the data network (INT) provided is the Internet.

11. A communications arrangement for extending a data network connection existing between a data network server (D) and a data network terminal (D_{A}),
having a data network server (D) for providing data network contents which has means for controlling setup of a voice link (SV) and means for controlling setup of a synchronized surfing session (SySS),
having a synchronized surfing server (S) for initiating and controlling a synchronized surfing session,
having a call server (C) for setting up connections (SV) in a voice network (PSTN) with means for receiving control signals via a data network (INT),
having a private branch exchange (N) with means for evaluating a suffix call number for incoming calls and means for determining a server ID for a synchronized surfing server (S) and a session ID for the synchronized surfing session (SySS) from the suffix call number and also means for influencing a data network terminal (D_{B}), the private branch exchange (N) prompting the data network terminal (D_{B}) to set up a connection to the synchronized surfing session (SySS) denoted by server ID and session ID.

12. A data network server (D) in a data network (INT), which provides information for retrieval by one or more data network terminals (D_{A}), characterized in that the data network server (D) has means for controlling setup of a synchronized surfing session (SySS) with the data network terminal (D_{A}) and a further data network terminal (D_{B}), and means for controlling setup of a voice link (SV) between voice terminals (T_{A}, T_{B}) associated with the data network terminals (D_{A}, D_{B}).

13. A private branch exchange (N) for connection to a public communications network (PSTN), characterized in that the private branch exchange (N) has means for evaluating a suffix call number for incoming calls and means for determining a server ID for a synchronized surfing server (S) and a session ID for a synchronized surfing session (SySS) from the suffix call number.

14. The private branch exchange (N) as claimed in claim 13, characterized in that the private branch exchange (N) has means for influencing a data network terminal (D_{B}), the private branch exchange (N) prompting the data network terminal (D_{B}) to set up a connection to the synchronized surfing session (SySS) denoted by server ID and session ID.

15. The private branch exchange (N) as claimed in claim 13, characterized in that the private branch exchange (N) has means for connecting telephones (T_{B}) which are in the form of data network terminals with a telephony function and means for converting data network telephony to circuit-switched telephony.
